(19) United States
(12) Patent Application Publication
(10) Pub. No.: US 2024/0234941 A1
(43) Pub. Date: Jul. 11, 2024

(54) BATTERY PACK

(71) Applicant: LG ENERGY SOLUTION, LTD., Seoul (KR)

(72) Inventors: Jae Hyun LEE, Daejeon (KR); Ju Hwan SHIN, Daejeon (KR); Hyoung Suk LEE, Daejeon (KR)

(73) Assignee: LG ENERGY SOLUTION, LTD., Seoul (KR)

(21) Appl. No.: 18/580,929

(22) PCT Filed: May 19, 2023
(86) PCT No.: PCT/KR2023/006812

§ 371 Date: Jan. 19, 2024

(30) Foreign Application Priority Data
May 24, 2022 (KR) 10-2022-0063181

(51) Int. Cl. H01M 50/383; H01M 10/48; H01M 50/204; H01M 50/289; H01M 50/367; H01M 50/375

(52) U.S. Cl. CPC H01M 50/383; H01M 10/486; H01M 50/204; H01M 50/289; H01M 50/367; H01M 50/375

(57) ABSTRACT

A battery pack includes a pack case including a base plate including a plurality of module regions each having the battery module located therein, a side wall extending along an edge of the base plate and vertically coupled to the base plate to surround the module regions, and a partition wall coupled to the side wall and configured to partition the base plate to form the plurality of module regions, wherein the side wall includes a gas-filled part that is filled with a high-pressure extinguishing gas therein and corresponds to the module region, a discharge port that is open to allow the gas-filled part to communicate with the module region, and a sealing plate coupled to the discharge port to seal the extinguishing gas, wherein the sealing plate is coupled to the discharge port so as to be separable in response to a temperature change in the module region.

The present application provides a benefit of priority on the basis of Korean Patent Application No. 10-2022-0063181, filed on May 24, 2022, and all contents disclosed in the literature of the Korean Patent Application are included as part of the present specification.

### TECHNICAL FIELD

The present invention relates to a battery pack.

### BACKGROUND ART

Lithium secondary batteries have risks such as explosion and fire due to heat generation, and thus securing safety is one of the main challenges for lithium secondary batteries. When such an abnormal phenomenon occurs, if it is not responded to appropriately in the beginning, the internal temperature of the secondary battery increases rapidly due to heat generation, the rapid increase in temperature may cause thermal runaway, and the thermal runaway may lead to an explosion of the secondary battery, which may propagate to adjacent secondary batteries and cause significant damage to a battery pack.

In order to remove this risk, a control device is provided to monitor and control the voltage, current, or the like of the battery pack, or when a fire occurs in the battery pack, a device is externally provided to extinguish the fire, but there is a problem in that it is not possible to promptly and actively respond to a fire occurring in the battery pack with only these members at an early stage.

### RELATED-ART DOCUMENT

Korean Patent Application Publication No. 10-2022-0004854

### DISCLOSURE

### Technical Problem

Accordingly, the present invention is directed to providing a battery pack including a fire extinguishing device therein.

Other objects and advantages of the present invention may be understood from the following detailed description and will become more fully apparent from the embodiments of the present invention. In addition, it will be easily understood that the objects and advantages of the present invention may be implemented by the means shown in the appended claims and combinations thereof.

### Technical Solution

One aspect of the present invention provides a battery pack configured to accommodate a battery module, the battery pack including a pack case including a base plate including a plurality of module regions each module region configured to have a battery module located therein, a side wall extending along an edge of the base plate and vertically coupled to the base plate to surround the plurality of module regions, and a partition wall coupled to the side wall and configured to partition the base plate to form the plurality of module regions, wherein the side wall includes a gas-filled part that is filled with a extinguishing gas at least one discharge port that is open to allow the gas-filled part to communicate with the plurality of module regions, and at least one sealing plate coupled to the at least one discharge port to seal the at least one discharge port, wherein the at least one sealing plate is coupled to the at least one discharge port so as to be separable in response to a temperature change in the module region.

The at least one sealing plate may be coupled to the at least one discharge port by a thermoplastic, and separated from the at least one discharge port as the thermoplastic is melted by a temperature above a melting point of the thermoplastic.

The at least one sealing plate may be formed of a thermoplastic material.

The at least one sealing plate may be melted by heat generated in the plurality of module regions to be separated from the at least one discharge port or to rupture.

A sealing resin, which is formed of a thermoplastic material along an edge of the at least one sealing plate, may be interposed between the at least one sealing plate and the at least one discharge port of the side wall, and the at least one sealing plate may be separated from the at least one discharge port as the sealing resin is melted by a temperature above a melting point of the thermoplastic.

The at least one discharge port may be a plurality of discharge ports and the at least one sealing plate may be a plurality of sealing plate, is separated from the respective one of the plurality of discharge ports, the extinguishing gas may be discharged to a respective one of the plurality of module regions.

The side wall may include a plurality of gas-filled parts respectively corresponding to the plurality of module regions.

The side wall may include a front frame provided on one side of the base plate in a lengthwise direction, a rear frame provided to face the front frame, and side frames provided in a hollow shape on opposite sides of the base plate in a widthwise direction, the at least one discharge port is a plurality of discharge ports and the at least one sealing plate is a plurality of sealing plate, and the plurality of gas-filled parts and the plurality of discharge ports may be formed in the side frame to correspond to each module region of the plurality of module regions.

The battery pack may further include an upper cover coupled to the open upper portion of the pack case so that the module region is covered, wherein the module region may be sealed by being surrounded by the upper cover, the base plate, the side wall, and the partition wall.

The extinguishing gas may include carbon dioxide.

The battery pack may further include a sensor configured to detect heat, pressure, or a fire in the plurality of module regions, wherein as the sensor detects an anomaly exceeding a preset temperature or pressure value or detects the occurrence of a fire, the at least one sealing plate may be separated from the at least one discharge port or rupture.

### Advantageous Effects

A battery pack of the present invention can extinguish a fire occurring in a battery module accommodated therein by rapidly spraying and discharging an extinguishing gas when the fire occurs.

In addition, according to the present invention, a phenomenon in which the inside of a battery module overheats due to a high-temperature gas generated in the battery module can be prevented, so that the temperature can be lowered.

### BRIEF DESCRIPTION OF THE DRAWINGS

FIG. 1 is a perspective view of a pack case included in a battery pack according to a first embodiment of the present invention.

FIG. 2 is a plan view of the pack case of (a) of FIG. 1.

FIG. 3 is a plan view of the pack case of (b) of FIG. 1.

FIG. 4 is a perspective view of the pack case included in the battery pack according to the first embodiment of the present invention and also illustrates a side frame with a portion cut out.

FIG. 5(a)-5(c) are views illustrating a cross section of the side frame included in the battery pack according to the first embodiment of the present invention.

FIG. 6 illustrates some of the side frame and a sealing plate that are adjacent to a module region.

FIG. 7 illustrates that the battery module is accommodated in the module region of FIG. 6.

FIGS. 8(a) and 8(b) are views schematically illustrating a process in which the sealing plate made of a thermoplastic material ruptures.

FIG. 9 illustrates some of the side frame and the sealing plate included in a battery pack according to a second embodiment of the present invention.

FIGS. 10(a) and 10(b) illustrate a process in which the sealing plate coupled to a discharge port by a sealing resin ruptures.

FIG. 11 is a perspective view of a battery pack according to a third embodiment.

FIG. 12 illustrates gas-filled parts formed inside the side frame in the battery pack of FIG. 11.

### BEST MODE

Hereinafter, exemplary embodiments of the present invention will be described in detail with reference to the attached drawings. Prior to this, terms or words used in the present specification and the following claims should not be construed as limited to common or dictionary meanings, and should be construed as meanings and concepts consistent with the technical spirit of the present invention based on the principle that the inventor(s) can appropriately define concepts and terms to explain the invention of the inventor in the best way.

Therefore, the embodiments described in the present specification and the configurations illustrated in the drawings are only the most preferred embodiments of the present invention and do not represent the full technical spirit of the present invention, and thus it should be understood that there are various equivalents and modifications that can replace them at the time of filing the present application.

Further, in the following description of the present invention, when it is determined that a detailed description of a related known configuration or function may obscure the gist of the present invention, the detailed description thereof is omitted.

The embodiments of the present invention are provided to more completely explain the present invention to those of ordinary skill in the art, and thus the shapes and sizes of components in the drawings may be exaggerated, omitted, or shown schematically for clarity of description. Thus, the size or proportion of each component does not fully reflect the actual size or proportion.

The present invention relates to a battery pack configured to accommodate a battery module B, and the battery pack of the present invention extinguishes a fire rapidly.

The battery pack of the present invention includes a pack case 1000 including a base plate 100, partition walls 300, and a side wall 200 including a gas-filled part 211 filled with an extinguishing gas G.

The extinguishing gas G used in the present invention is used for the purpose of extinguishing a fire or lowering a temperature when the fire occurs in the accommodated battery module B or when a high-temperature gas is generated in the battery module B, and for example, carbon dioxide or the like is used as the extinguishing gas G. However, the present invention is not limited thereto, and any material that can fulfill the purpose of the present invention may be used.

The battery pack of the present invention can be largely divided into two embodiments according to the structure of the side wall 200.

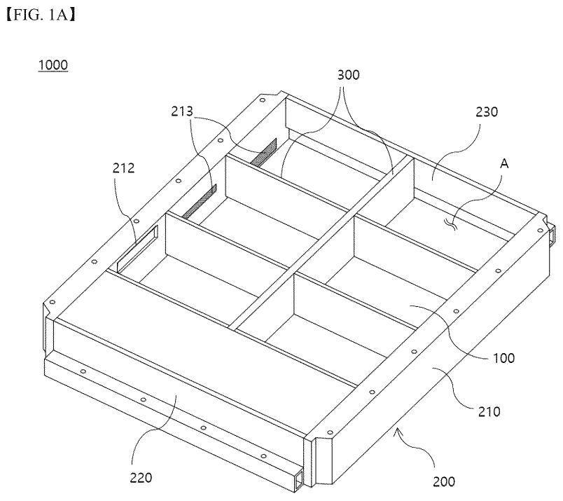

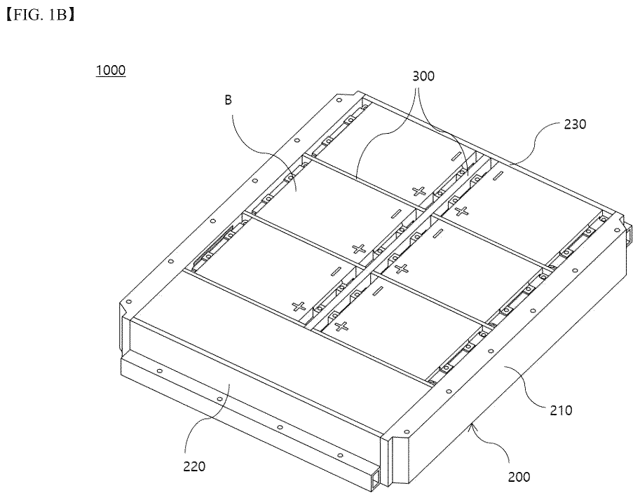

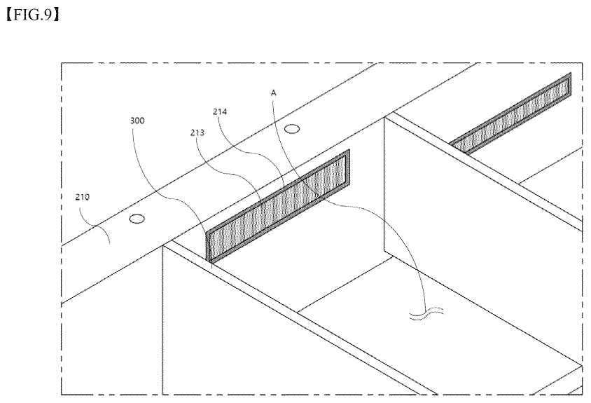

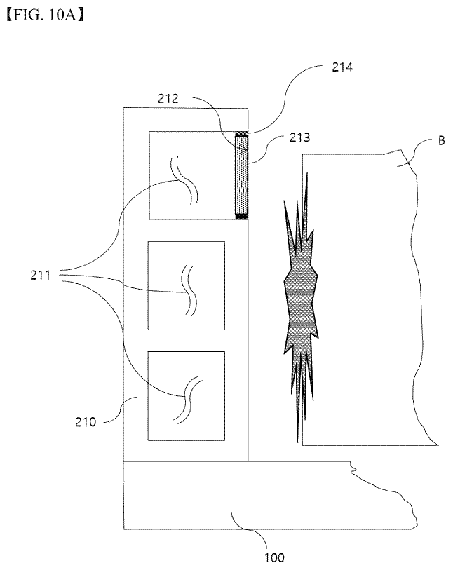

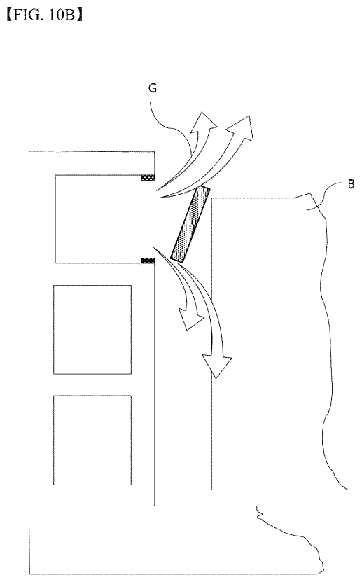

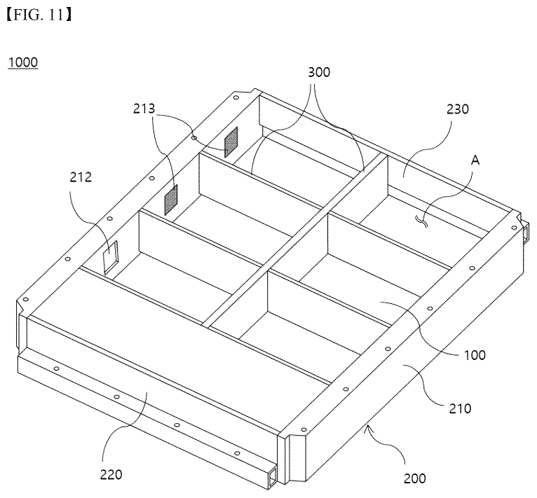

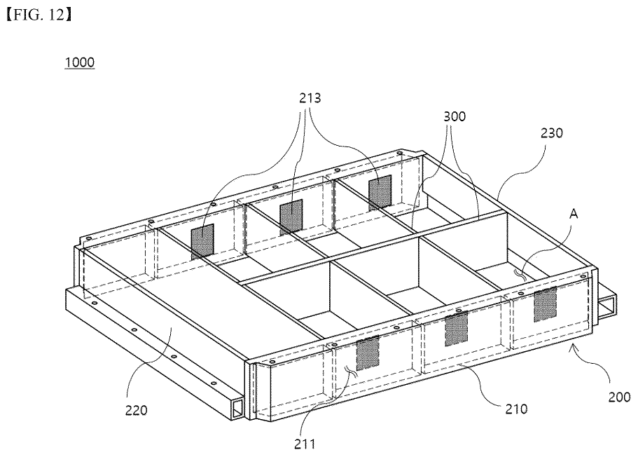

FIGS. 1 to 8 relate to a battery pack according to a first embodiment of the present invention, FIGS. 9 and 10 relate to a battery pack according to a second embodiment of the present invention, and FIGS. 11 and 12 relate to a battery pack according to a third embodiment of the present invention.

Hereinafter, the battery pack of the present invention will be described with reference to the drawings.

### First Embodiment

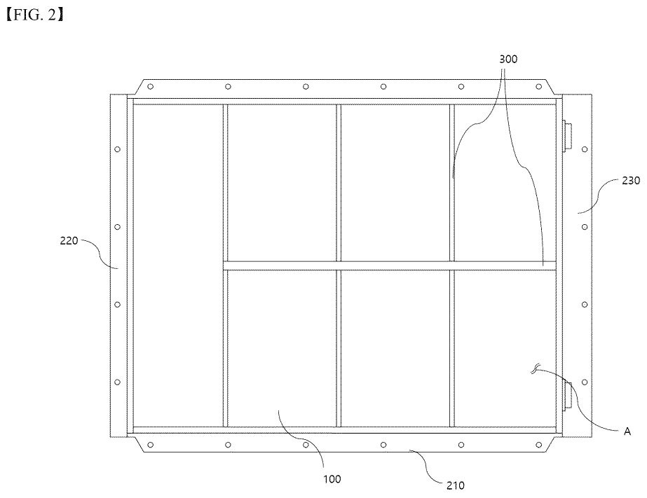

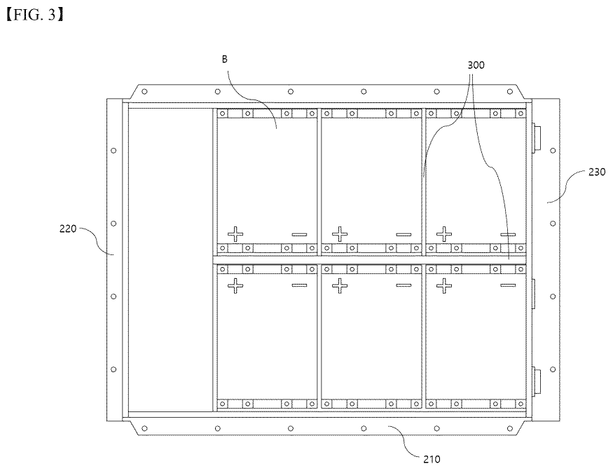

FIG. 1 is a perspective view of the pack case 1000 included in the battery pack according to the first embodiment of the present invention, FIG. 2 is a plan view of the pack case 1000 of (a) of FIG. 1, and FIG. 3 is a plan view of the pack case 1000 of (b) of FIG. 1. According to (a) of FIG. 1 and FIG. 2, the pack case 1000 of the present invention includes the base plate 100, the side wall 200, and the partition walls 300.

As illustrated in the drawings, the pack case 1000 includes a plurality of module regions A in which a plurality of battery modules B may be separated and accommodated. The module regions A are formed by being partitioned by the side wall 200 and the partition walls 300.

The base plate 100 includes the plurality of module regions A in which the battery modules B are located. More specifically, as illustrated in (b) of FIG. 1 and FIG. 3, the battery modules B are inserted into the module regions A, respectively, and seated on the base plate 100.

The side wall 200 is formed to extend along an edge of the base plate 100 to surround the module regions A and is vertically coupled to the base plate 100.

The partition walls 300 are coupled to the side wall 200 and partition the base plate 100 to form the plurality of module regions A. More specifically, the partition walls 300 include a main partition wall 300 extending in a lengthwise direction of the base plate 100 so as to cross the base plate 100, and sub-partition walls 300 each having both ends coupled to the main partition wall 300 and the side wall 200 and spaced apart from each other by a predetermined interval along the lengthwise direction of the main partition wall 300 and coupled to the base plate 100.

Further, although not illustrated in the drawing, the battery pack of the present invention may further include an upper cover (not shown) that is coupled to an open upper portion of the pack case 1000 so that the module region A is covered thereby. Thus, the module region A may be sealed by being surrounded by the upper cover, the base plate 100, the side wall 200, and the partition wall 300.

The side wall 200 of the present invention is composed of a front frame 220, a rear frame 230, and side frames 210. More specifically, as illustrated in FIGS. 1 to 3, the side wall 200 includes the front frame 220 provided on one side of the base plate 100 in the lengthwise direction, the rear frame 230 provided to face the front frame 220, and the side frames 210 provided in a hollow shape on both sides of the base plate 100 in a widthwise direction.

The side wall 200 includes the gas-filled part 211 filled with a high-pressure extinguishing gas G therein, a discharge port 212 that is open to allow the gas-filled part 211 to communicate with the module region A, and a sealing plate 213 coupled to the discharge port 212. More specifically, the gas-filled part 211 is included in the side frame 210.

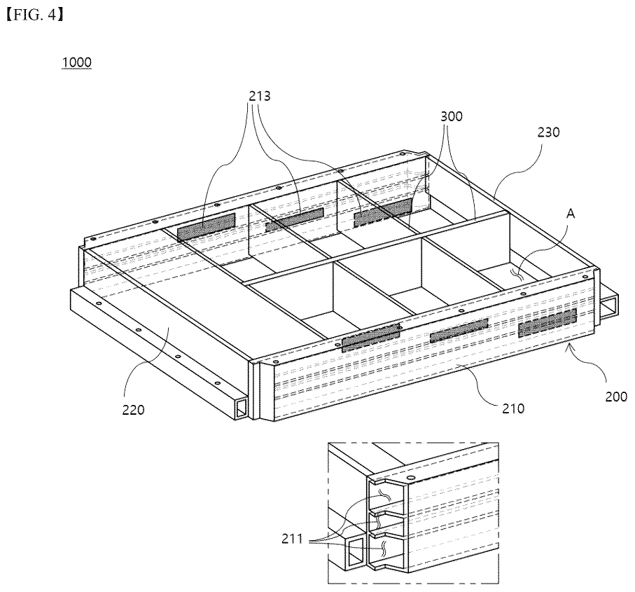

FIG. 4 is a perspective view of the pack case 1000 included in the battery pack according to the first embodiment of the present invention and also illustrates the side frame 210 with a portion cut out.

According to FIG. 4, each side frame 210 includes a gas-filled part 211 corresponding to the module region A abutting the side frame 210.

The gas-filled parts 211 are separated from each other so as not to communicate with each other, and each gas-filled part 211 is filled with the high-pressure extinguishing gas G.

Any one gas-filled part 211 included in the side frame 210 corresponds to any one module region A adjacent to the side frame 210. That is, the side frame 210 includes a plurality of gas-filled parts 211 respectively corresponding to the module region A adjacent thereto.

More specifically, the gas-filled part 211 extends in a lengthwise direction of the side frame 210, and the extending gas-filled part 211 communicates with the corresponding module region A through the discharge port 212. Thus, the number of gas-filled part 211 and the discharge port 212 of the present invention are formed to correspond to the number of the module regions A included in the pack case 1000.

The plurality of gas-filled parts 211 included in the battery pack according to the first embodiment of the present invention are separated from each other in a height direction of the side frame 210 and are included in the side frame 210. In an example, when three module regions A are adjacent to one side frame 210 as illustrated in FIG. 4, three gas-filled parts 211 that do not communicate with each other are sequentially formed in the height direction of the side frame 210 and included in the side frame 210. In addition, each gas-filled part 211 communicates with the corresponding module region A through the discharge port 212 that is open in the side wall 200 adjacent to the corresponding module region A. Accordingly, the sealing plates 213 for blocking the discharge ports 212 corresponding to the gas-filled parts 211 may also be formed at different heights in the module regions A, respectively.

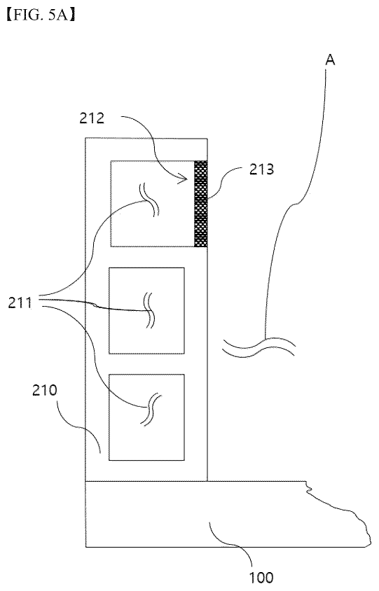

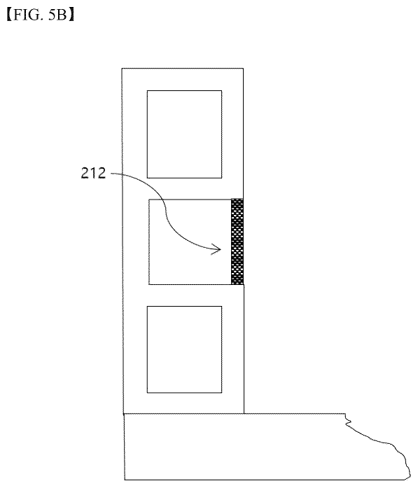

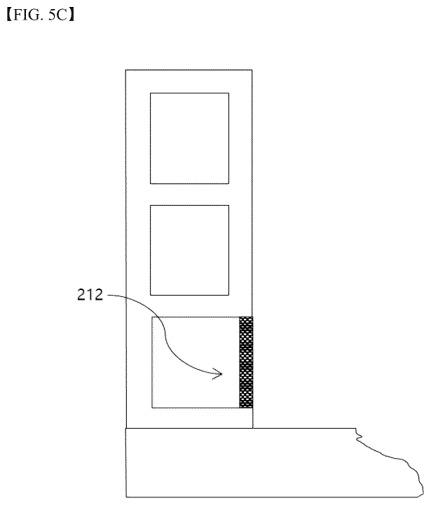

FIG. 5 is a view illustrating a cross section of the side frame 210 included in the battery pack according to the first embodiment of the present invention.

According to FIG. 5(a), a gas-filled part 211 is formed in an upper portion of the side frame 210, and a sealing plate 213 is coupled to a discharge port 212, which is open toward a module region A corresponding to the gas-filled part 211. According to FIG. 5(b), a gas-filled part 211 is formed in a middle portion of the side frame 210, and a sealing plate 213 is coupled to a discharge port 212, which is open toward a module region A corresponding to the gas-filled part 211. According to FIG. 5(c), a gas-filled part 211 is formed in a lower portion of the side frame 210, and a sealing plate 213 is coupled to a discharge port 212, which is open toward a module region A corresponding to the gas-filled part 211.

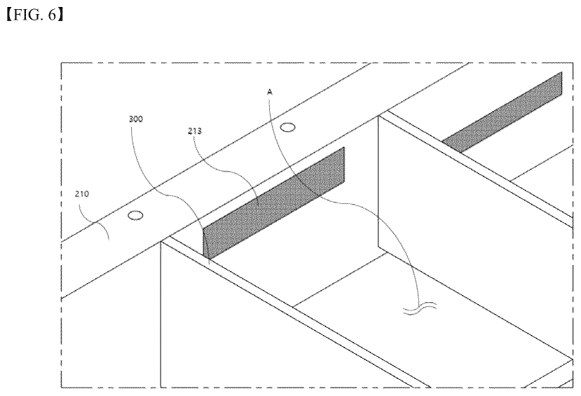

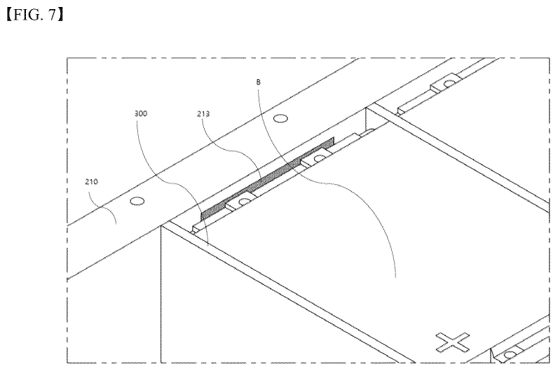

FIG. 6 illustrates some of the side frame 210 and the sealing plate 213 that are adjacent to the module region A, and FIG. 7 illustrates that the battery module B is accommodated in the module region A of FIG. 6.

As illustrated in FIG. 6, the discharge port 212 maintains a state of being blocked by the sealing plate 213 coupled to the discharge port 212 so that the extinguishing gas G filled in the gas-filled part 211 is sealed.

In the battery pack of the present invention, the sealing plate 213 that blocks the discharge port 212 is separated in response to a change in temperature of the module region A corresponding to the discharge port 212. That is, as illustrated in FIG. 7, when the battery module B accommodated in the module region A deteriorates or a high-temperature gas is discharged, the sealing plate 213 adjacent to the battery module B may be weakened by heat generated from the battery module B and separated from the discharge port 212.

By the separation of the sealing plate 213, the extinguishing gas G filled at high pressure is discharged through the open discharge port 212. A fire or the like in the battery module B accommodated in the corresponding module region A may be extinguished by the discharge of the extinguishing gas G.

The sealing plate 213 is coupled to the discharge port 212 by a thermoplastic. Thus, the sealing plate 213 may be separated from the discharge port 212 as the thermoplastic is melted by the high-temperature heat generated in the module region A.

The thermoplastic may be, for example, a polyethylene resin, a polypropylene resin, or the like. However, the present invention is not limited thereto, and any material having a property of being melted or partially weakened at a predetermined temperature while having excellent strength against pressure may be used as the thermoplastic material.

More specifically, the sealing plate 213 is formed of a thermoplastic material and may be manufactured by injection or compression molding.

The sealing plate 213 made of the thermoplastic material may be melted by heat above the melting point of the thermoplastic to be separated from the discharge port 212 or rupture.

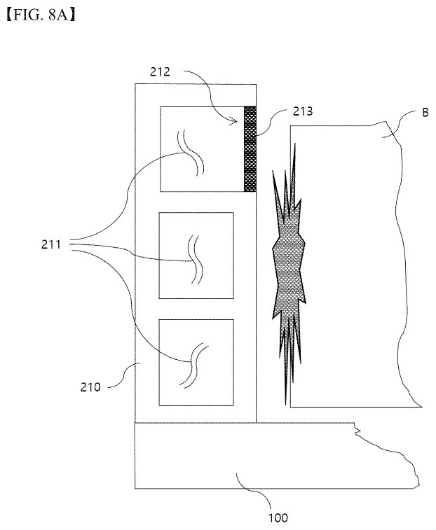

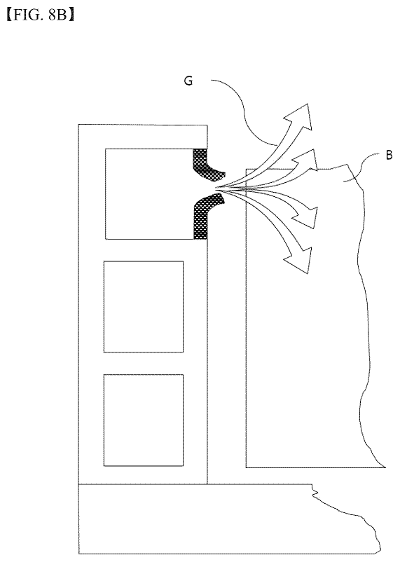

FIG. 8 is a view schematically illustrating a process in which the sealing plate 213 made of a thermoplastic material ruptures.

As illustrated in FIG. 8(a), when an anomaly in which there is a fire or high-temperature gas in the battery module B occurs, the sealing plate 213 adjacent to the module region A in which the corresponding battery module B is accommodated starts to be weakened or melted by heat. Subsequently, as illustrated in FIG. 8(b), the weakened sealing plate 213 is unable to withstand the pressure of the extinguishing gas G filled at high pressure in the gas-filled part 211 and ruptures, and the extinguishing gas G may be discharged from the discharge port 212 due to the rupture of the sealing plate 213 so that the temperature of the module region A may be lowered.

The battery pack of the present invention may further include a sensor (not shown) in each module region A in which the battery module B is seated.

The sensor is used for the purpose of detecting heat, pressure, or a fire, detects an anomaly exceeding a preset temperature or pressure value, or detects the occurrence of a fire.

The battery pack of the present invention may further include a fixing member (not shown) that is interlocked with the sensor and slidably coupled to the discharge port 212 of the side frame 210 in order to fix the sealing plate 213. In this case, the fixing member moves backward from the sealing plate 213 in response to a signal from the sensor so that the sealing plate 213 advances in a direction of the module region A.

Further, the battery pack of the present invention may further include a striking member (not shown) that is interlocked with the sensor and coupled to the side frame 210 so as to move forward toward and backward from the sealing plate 213 to strike and rupture the sealing plate 213. In this case, the striking member moves forward toward the sealing plate 213 to strike the sealing plate 213 in response to a signal from the sensor.

### Second Embodiment

Unlike the battery pack according to the first embodiment, in which the sealing plate 213 is made of a thermoplastic material, in the battery pack according to the second embodiment of the present invention, a sealing resin 214 including a thermoplastic material is formed along the edge of the sealing plate 213 to allow the sealing plate 213 to be coupled to the discharge port 212.

FIG. 9 illustrates some of the side frame 210 and the sealing plate 213 included in the battery pack according to the second embodiment of the present invention.

As illustrated in FIG. 9, the battery pack according to the second embodiment of the present invention may further include the sealing resin 214 interposed between the sealing plate 213 and the discharge port 212.

The sealing plate 213 is separated from the discharge port 212 as the sealing resin 214 formed along the edge of the sealing plate 213 is melted by high-temperature heat.

FIG. 10 schematically illustrates a process in which the sealing plate 213 coupled to the discharge port 212 by the sealing resin 214 ruptures.

As illustrated in FIG. 10(a), when an anomaly in which there is a fire or high-temperature gas in the battery module B occurs, the sealing resin 214 formed on the edge of the sealing plate 213 adjacent to the module region A in which the corresponding battery module B is accommodated starts to be weakened or melted by heat. Subsequently, as illustrated in FIG. 10(b), the weakened sealing resin 214 is unable to withstand the pressure of the extinguishing gas G filled at high pressure in the gas-filled part 211 and ruptures, and the sealing plate 213 coupled to the discharge port 212 by the sealing resin 214 is pushed by the pressure of the extinguishing gas G and moves away from the discharge port 212. The extinguishing gas G is discharged from the discharge port 212 by the separation of the sealing plate 213 so that the temperature of the module region A may be lowered.

### Third Embodiment

In the battery pack according to the third embodiment of the present invention, the plurality of gas-filled parts 211 are formed separately from each other in the lengthwise direction of the side frame 210. That is, unlike the battery pack according to the first embodiment, in which the gas-filled parts 211 formed inside the side frame 210 are formed to extend in the lengthwise direction of the side frame 210, in the battery pack according to the third embodiment, each gas-filled part 211 is separated to correspond to each module region A and included in the side frame 210.

FIG. 11 is a perspective view of the battery pack according to the third embodiment, and FIG. 12 illustrates the gas-filled parts 211 formed inside the side frame 210 in the battery pack of FIG. 11.

As illustrated in FIG. 11, the discharge port 212 is formed in the side frame 210 to correspond to a corresponding section in each module region A. and the sealing plate 213 is coupled to each corresponding discharge port 212.

Further, a plurality of gas-filled parts 211 included in the side frame 210 are formed separately from each other in the lengthwise direction of the side frame 210. In an example, when three module regions A are adjacent to one side frame 210 as illustrated in FIG. 12, three gas-filled parts 211 that do not communicate with each other are sequentially formed in the lengthwise direction of the side frame 210 and included in the side frame 210. In addition, each gas-filled part 211 communicates with the corresponding module region A through the discharge port 212 that is open in the side wall 200 adjacent to the corresponding module region A.

The present invention has been described above in more detail with reference to the drawings and embodiments. However, the embodiments described in the present specification and the configurations illustrated in the drawings are only an embodiment of the present invention and do not represent the full technical spirit of the present invention, and thus it should be understood that there are various equivalents and modifications that can replace them at the time of filing the present application.

### DESCRIPTION OF REFERENCE NUMERALS

1000: pack case
100: base plate
200: side wall
210: side frame
211: gas-filled part
212: discharge port
213: sealing plate
214: scaling resin
220: front frame
230: rear frame
300: partition wall
A: module region
B: battery module
G: extinguishing gas

1-11. (canceled)

12. A battery pack comprising:
a pack case including:
a base plate including a plurality of module regions, each module region configured to have a battery module located therein;
a side wall extending along an edge of the base plate and vertically coupled to the base plate to surround the plurality of module regions; and
a partition wall coupled to the side wall and configured to partition the base plate to form the plurality of module regions,
wherein the side wall includes a gas-filled part that is filled with a extinguishing gas, at least one discharge port that is open to allow the gas-filled part to communicate with the plurality of module regions, and at least one sealing plate coupled to the at least one discharge port to seal the at least one discharge port, and
wherein the at least one sealing plate is coupled to the at least one discharge port so as to be separable in response to a temperature change in the module region.

13. The battery pack of claim 12, wherein the at least one sealing plate is coupled to the at least one discharge port by a thermoplastic and separated from the at least one discharge port as the thermoplastic is melted by a temperature above a melting point of the thermoplastic.

14. The battery pack of claim 12, wherein the at least one sealing plate is formed of a thermoplastic material.

15. The battery pack of claim 14, wherein the at least one sealing plate is melted by heat generated in the plurality of module regions to be separated from the at least one discharge port or to rupture.

16. The battery pack of claim 12, wherein a sealing resin, which is formed of a thermoplastic material along an edge of the at least one sealing plate, is interposed between the at least one sealing plate and the at least one discharge port of the side wall, and
wherein the at least one sealing plate is separated from the at least one discharge port as the sealing resin is melted by a temperature above a melting point of the thermoplastic.

17. The battery pack of claim 12, wherein the at least one discharge port is a plurality of discharge ports and the at least one sealing plate is a plurality of sealing plates,
wherein as one of the plurality of sealing plates is separated from a respective one of the plurality of discharge ports, the extinguishing gas is discharged to a respective one of the plurality of module regions.

18. The battery pack of claim 12, wherein the side wall includes a plurality of gas-filled parts respectively corresponding to the plurality of module regions.

19. The battery pack of claim 18, wherein the side wall includes a front frame provided on one side of the base plate in a lengthwise direction, a rear frame provided to face the front frame, and side frames provided in a hollow shape on opposite sides of the base plate in a widthwise direction,
wherein the at least one discharge port is a plurality of discharge ports and the at least one sealing plate is a plurality of sealing plates, and
wherein the plurality of gas-filled parts and the plurality of discharge ports are formed in the side frame to correspond to each module region of the plurality of module regions.

20. The battery pack of claim 19, wherein the plurality of gas-filled parts extend in a lengthwise direction of one of the side frames, and the plurality of gas-filled parts communicate with a respective one of the plurality of module regions through a respective one of the plurality of discharge ports.

21. The battery pack of claim 19, wherein the plurality of gas-filled parts are formed separately from each other in a lengthwise direction of the side frame.

22. The battery pack of claim 12, further comprising an upper cover coupled to an open upper portion of the pack case so that the plurality of module regions are covered thereby,
wherein the plurality of module regions are sealed by being surrounded by the upper cover, the base plate, the side wall, and the partition wall.

23. The battery pack of claim 12, wherein the extinguishing gas includes carbon dioxide.

24. The battery pack of claim 12, further comprising a sensor configured to detect heat, pressure, or a fire in the plurality of module regions,
wherein as the sensor detects an anomaly exceeding a preset temperature or pressure value or detects the occurrence of a fire, the at least one sealing plate is separated from the at least one discharge port or ruptures.
